(19) United States
(12) Patent Application Publication
(10) Pub. No.: US 2025/0119398 A1
(43) Pub. Date: Apr. 10, 2025

(54) COMMUNICATION METHOD, CLIENT, SERVER CONTROL METHOD, AND STORAGE MEDIUM

(71) Applicant: BEIJING ZITIAO NETWORK TECHNOLOGY CO., LTD., Beijing (CN)

(72) Inventor: Zhiqin LI, Beijing (CN)

(21) Appl. No.: 18/267,733

(22) PCT Filed: Dec. 17, 2021
(86) PCT No.: PCT/CN2021/139067

§ 371 Date: Jun. 15, 2023

(30) Foreign Application Priority Data
Dec. 18, 2020 (CN) 202011507342.4

(51) Int. Cl. H04L 51/046; H04L 51/18

(52) U.S. Cl. CPC H04L 51/046; H04L 51/18

(57) ABSTRACT

The present invention provides a communication method, a client, a server control method, and a storage medium. In some embodiments, the present invention provides a communication method, comprising: determining a first symbol inputted on the basis of a first client; sending the first symbol to a second client to cause the second client to display a second symbol which has the same meaning as the first symbol; or, determining a second symbol according to the first symbol and regional information of the second client, and sending the second symbol to the second client, wherein the first symbol and the second symbol are different symbols and have the same meaning. The method provided by the present invention can solve the communication problem caused by using habits of users, without changing the using habits.

### CROSS-REFERENCE

The present application is proposed based on a Chinese patent application with the application number of 202011507342.4 and the application date of Dec. 18, 2020 and titled “COMMUNICATION METHOD, CLIENT, SERVER CONTROL METHOD, AND STORAGE MEDIUM”, and claims the priority of the Chinese patent application, the disclosure of which is hereby incorporated by reference in its entirety.

### TECHNICAL FIELD

The present disclosure relates to the field of computer technology, in particular to a communication method, a client, a server control method, and a storage medium.

### BACKGROUND

Communication clients, such as instant messaging clients, are used to communicate with other communication software. During communication, symbols such as expressions and pictures are sometimes sent to express user's meanings. These symbols can enrich ways of expression and increase fun.

### SUMMARY

The present application provides a communication method, client, server control method, and storage medium.

The present application adopts the following technical solution.

Some embodiments of the disclosure provide a communication method, comprising:
determining a first symbol based on input of a first client;
sending the first symbol to a second client to instruct the second client to display a second symbol having a same implication as the first symbol; or determining a second symbol according to the first symbol and regional information of a second client, and sending the second symbol to the second client;
wherein the first symbol and the second symbol are different symbols and have the same implication.

Some embodiments of the disclosure provide a communication method, comprising: receiving a first symbol sent by a first client;
determining a second symbol having a same implication as the first symbol, and displaying the second symbol;
wherein the first symbol and the second symbol are different symbols and have the same implication.

Some embodiments of the disclosure provide a control method for a server, comprising:
receiving a first symbol sent by a first client;
determining a second symbol having a same implication as the first symbol;
sending the second symbol to a second client, so that the second client displays the second symbol;
wherein the first symbol and the second symbol are different symbols and have the same implication.

Some embodiments of the disclosure provide a communication client, comprising: an input unit, configured to determine an input first symbol;
a sending unit, configured to send the first symbol to a second client to instruct the second client to display a second symbol having a same implication as the first symbol, or a sending unit, configured to determine a second symbol according to the first symbol and regional information of a second client, and send the second symbol to the second client, wherein
the first symbol and the second symbol are different symbols.

Some embodiments of the disclosure provide a communication client, comprising:
a receiving unit, configured to receive a first symbol sent by a first client;
a processing unit, configured to determine a second symbol having a same implication as the first symbol; and
a display unit, configured to display the second symbol;
wherein the first symbol and the second symbol are different symbols.

Some embodiments of the disclosure provide a server, comprising:
a receiving module, configured to receive a first symbol sent by a first client;
a processing module, configured to determine a second symbol having a same implication as the first symbol;
a sending module, configured to send the second symbol to a second client, so that the second client displays the second symbol;
wherein the first symbol and the second symbol are different symbols and have the same implication.

Some embodiments of the disclosure provide an electronic device, comprising: at least one memory and at least one processor;
wherein the at least one memory is configured to store program code, and the at least one processor is configured to call the program code stored in the at least one memory to perform the method above.

Some embodiments of the disclosure provide a storage medium storing program code for performing the method above.

A communication method provided in some embodiments of the present disclosure includes: determining a first symbol based on input of a first client; and sending the first symbol to a second client to instruct the second client to display a second symbol having a same implication as the first symbol; or determining a second symbol according to the first symbol and regional information of a second client, and sending the second symbol to the second client, where the first symbol and the second symbol are different symbols and have the same implication. The second client displays the second symbol that is different from the first symbol but has the same implication as the first symbol, which may avoid misunderstandings caused by usage habits and other reasons. Moreover, because the first symbol is based on the input of the first client and the second symbol is displayed by the second client, users of the two clients may operate or view the symbols that they easily understand, without changing their own usage habits to adapt to others' usage habits. Therefore, communication is more convenient and efficient.

### BRIEF DESCRIPTION OF THE DRAWINGS

The above and other features, advantages, and aspects of each embodiment of the present disclosure will become more apparent by combining the accompanying drawings and referring to the following specific implementation methods. Throughout the accompanying drawings, identical or similar reference numerals represent identical or similar elements. It should be understood that the attached drawings are schematic, and components and elements may not necessarily be drawn to scale.

FIG. 1 is a flowchart of a communication method according to an embodiment of the present disclosure.

FIG. 2 is a flowchart of another communication method according to an embodiment of the present disclosure.

FIG. 3 is a flowchart of another communication method according to an embodiment of the present disclosure.

FIG. 4 is a flowchart of a control method for a server according to an embodiment of the present disclosure.

FIG. 5 is a composition diagram of a communication client according to an embodiment of the present disclosure.

FIG. 6 is a composition diagram of another communication client according to an embodiment of the present disclosure.

FIG. 7 is a composition diagram of a server according to an embodiment of the present disclosure.

FIG. 8 is a schematic structural diagram of an electronic device according to an embodiment of the present disclosure.

### DETAILED DESCRIPTION OF PREFERRED EMBODIMENTS

Embodiments of the present disclosure will be described in greater detail below with reference to the accompanying drawings. While certain embodiments of the present disclosure are shown in the accompanying drawings, it should be understood that the present disclosure may be implemented in various forms and should not be construed as being limited to the embodiments set forth herein, but instead are provided for a more thorough and complete understanding of the present disclosure. It should be understood that the accompanying drawings and embodiments of the present disclosure are for exemplary purposes only and are not intended to limit the scope of protection of the present disclosure.

It should be understood that the individual steps documented in the method embodiments of the present disclosure may be performed in sequence and/or in parallel. In addition, the method embodiments may include additional steps and/or omit to perform the steps illustrated. The scope of the present disclosure is not limited in this regard.

The term “includes” and variations thereof as used herein are open-ended, i.e., “includes but is not limited to”. The term “based on” is “based, at least in part, on”. The term “an embodiment” means “at least one embodiment”; the term “another embodiment” means “at least one additional embodiment”; the term “some embodiments” means “at least some embodiments”. Definitions of other terms will be given in the description below.

It should be noted that the concepts of “first” and “second” mentioned in this disclosure are used only to distinguish between different devices, modules or units, and are not intended to define the order or interdependence of the functions performed by these devices, modules or units.

It should be noted that the modification “one” referred to in this disclosure is illustrative rather than limiting, and it should be understood by those skilled in the art to mean “one or more” unless the context clearly indicates otherwise.

The names of the messages or information interacted between the plurality of devices in this implementation of the disclosure are used for illustrative purposes only and are not intended to limit the scope of those messages or information.

Communication clients, such as instant messaging clients, are used to communicate with other similar communication clients. During communication, symbols such as expressions and pictures may be sent to increase fun of communication and enrich ways of communication. However, some symbols may have different meanings in different regions, sometimes leading to misunderstandings. For example, gesture OK indicates consent in some regions, but is misunderstood as other meanings in other regions. In some regions, nodding indicates yes, shaking the head indicates no, while the opposite is true in other regions. In this case, sending expressions may cause communication errors and misunderstandings of meanings.

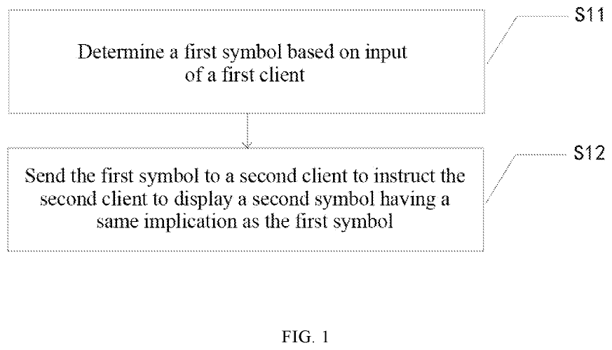

A communication method is provided in the present disclosure, as shown in FIG. 1, including:

S11: Determine a first symbol based on input of a first client.

In some embodiments, a user may input the first symbol in an input box of the first client, or select the first symbol from optional symbols provided by the first client, and the input first symbol may be displayed on a communication interface of the first client. The first symbol may be, for example, an expression, or a graphical reply identifier about likes, love, and the like for information such as text, a document, and a video.

S12: Send the first symbol to a second client to instruct the second client to display a second symbol having a same implication as the first symbol.

In some embodiments, the first client is in communication connection with the second client. The first client sends the first symbol to the second client after determining the first symbol. The first client may directly send the first symbol to the second client or send the first symbol to a server, and the server forwards the first symbol to the second client.

In other embodiments of the present disclosure, with reference to FIG. 2, another communication method includes:

S11: Determine a first symbol based on input of a first client.

S13: Determine a second symbol according to the first symbol and regional information of a second client, and send the second symbol to the second client.

In some embodiments, the regional information may include various forms of information. In some embodiments, the regional information includes information that can identify usage habits related to a region, the regional information of a client may be information related to a physical address location of the client, and the regional information of a client may alternatively be registration place information of the client or registration place information of an authorized user of the client. The regional information is not limited to these.

In some embodiments, the second client displays the second symbol that is different from the first symbol but has the same implication as the first symbol, which may avoid misunderstandings caused by usage habits and other reasons. Moreover, because the first symbol is based on the input of the first client and the second symbol is displayed by the second client, users of the two clients may operate or view the symbols that they easily understand without changing their own usage habits to adapt to others' usage habits, and do not need to perform additional operations to adapt to others when sending symbols. Therefore, the communication method is more convenient, efficient, and in line with user's usage habits. In some embodiments, different symbol packages may be used on the first client and the second client respectively. A first user inputs the first symbol through the first client, and after the second client receives the first symbol, the second symbol having the same implication as the first symbol is displayed from a symbol package used by the second client. The second symbol is a symbol that conforms to usage habits of a user of the second client, so that a second user using the second client can better understand the meaning of the first user to avoid misunderstandings.

In some embodiments of the present disclosure, the first symbol is related to regional information of the first client. In some embodiments, the second symbol is related to the regional information of the second client. The regional information may include various forms of information. In some embodiments, the regional information includes regional information that can identify culture related to a region, the regional information of a client may be information related to a physical address location of the client, and the regional information of a client may alternatively be registration place information of the client or registration place information of an authorized user of the client. The regional information is not limited to these. In some embodiments, the same symbol has different implications in different places. For example, the meaning of nodding is yes in some regions and no in others. In some embodiments, the regional information of the first client reflects usage habits of a user of the first client, while the regional information of the second client reflects usage habits of a user of the second client. Defining the correlation between the first symbol and the regional information of the first client and the correlation between the second symbol and the regional information of the second client may ensure that the implications of the first symbol and the second symbol conform to users' relevant usage habits. After the first client inputs the first symbol, symbol conversion may be performed according to a first symbol package used by the first client and a second symbol package used by the second client, so that the first symbol is converted into the second symbol having the same implication in the second symbol package, and the users can clearly and accurately understand the implications of the symbols.

In some embodiments of the present disclosure, the regional information of the first client is determined according to at least one of a version, a language, a location, authorized login user information, a network address, a content distribution network, and a user choice of the first client. In some embodiments of the present disclosure, the regional information of the second client is determined according to at least one of a version, a language, a location, authorized login user information, a network address, a content distribution network, and a user choice of the second client. User's authorization for information such as location information and login user information may be obtained previously in various ways, and then the information is used within an authorized scope, for example, to determine regional information related to a symbol.

In some embodiments, there may be many methods for determining regional information. The regional information of the second client may be determined through a version of the client. Generally, a user uses a client in his own country, and the version of the client may reflect user's regional information, thereby determining usage habits related to the regional information; for the user, the downloaded version of the client is generally a version that is used habitually and matches his usage habits; when the user goes abroad or changes his geographical location, he usually does not change the version of the client he is using; and consequently, determining the regional information based on the version of the client may avoid a problem of mismatch between the second symbol and usage habits when the user goes abroad or changes his geographical location. In some embodiments, the regional information of the client may alternatively be determined according to a language of the client, which is usually user's native language and can reflect a language family of the client user. In some embodiments, the regional information of the client may be determined according to location information of the client, and the location information of the client may determine a location of the client. In some embodiments, the location of the second client may be determined according to a content distribution network of the client, where the content distribution network usually covers only nearby areas and can locate an approximate range of the client. In some embodiments, data in the client are processed by a node server of the content distribution network during actual use; when the client is used, the corresponding content distribution network and the corresponding node server need to be determined, while the regional information of the client is determined, so additional operations are not required; and determining the regional information through the content distribution network may be directly based on a location of the node server, without obtaining privacy information of the client, which is conducive to protecting privacy. In some embodiments, the regional information of the client is determined according to login user information authorized by the second client, where the login user information can reflect symbols that the user is accustomed to using, thereby ensuring that the second symbol conforms to the usage habits of the user. In some embodiments, the location of the second client is determined according to a network address (such as an IP address) of the second client. In some embodiments, the regional information is determined according to a user choice, and the regional information chosen by the user is usually a region that the user is familiar with, thereby ensuring that the user can understand the implication of the second symbol determined according to the regional information.

In some embodiments of the present disclosure, the first symbol and/or the second symbol include symbol content, or symbol content and a symbol format, and at least one of the symbol content and symbol formats of the first symbol and the second symbol is different. In some embodiments, the symbol content may be content of an expression or picture displayed by the symbol, and the symbol format may be a display style or layout of the symbol. In some cases, users from different regions may have different understandings of the implication of the same symbol, the symbol content of the first symbol and the symbol content of the second symbol may be different, and changing the symbol content ensures that information content is correctly conveyed. In some embodiments, the users of the first client and the second client may discuss the symbol sent by the user of the first client during communication. If the difference between the first symbol and the second symbol is small, communication disorders occurring during communication may be avoided. Therefore, when the second symbol is determined, a symbol that is most similar to the first symbol is selected, that is, only necessary parts of the first symbol are modified, so that the generated second symbol is as similar to the first symbol as possible while correctly expressing the implication, to ensure smooth communication between the users.

In some embodiments of the present disclosure, the symbol content includes at least one of an expression, a skin, a graphic identifier, and a picture. In some embodiments, the symbol format includes arrangement of different parts of a timestamp. In some embodiments, the skin may be the skin of the expression, such as a color or font used for the expression; the graphic identifier may be a like symbol for liking communication information, a consent symbol for expressing consent on communication information, or the like; and the timestamp may be a representation of time, such as in some regions, the date is usually abbreviated in a form of year, month, and day, while in other regions, the year is written last. If abbreviations are used during communication, such as abbreviating 2012 to 12, misunderstandings may be caused. In some embodiments, the first symbol and the second symbol may be symbols of the same type. For example, when the first symbol is an expression, the second symbol is also an expression. By keeping the types of the first symbol and the second symbol consistent, the user's meaning may be expressed more accurately. In some cases, the user may discuss the sent symbol. For example, after the user of the first client sends a picture, the sent picture may be discussed. If the picture sent by the user of the first client is changed to text, the user of the second client may not understand what is being discussed when the user discusses the picture, leading to communication problems. Therefore, defining the first symbol and the second symbol to the same type may reduce the communication problems.

In some embodiments, the first client uses a first symbol package including the first symbol; and the second client uses a second symbol package including the second symbol, where at least some symbols in the first symbol package and at least some symbols in the second symbol package are different but have the same implications. In some embodiments, the first symbol package and the second symbol package may be symbol packages used by the first client and the second client respectively. In this case, the implication of each symbol in the first symbol package and the second symbol package is definite and pre-knowable, the user of the first client is familiar with the first symbol package, and the user of the second client is familiar with the second symbol package. After the first client inputs the first symbol, symbol conversion may be performed according to the first symbol package used by the first client and the second symbol package used by the second client, so that the first symbol is converted into the second symbol having the same implication in the second symbol package. Using the first symbol package and the second symbol package can ensure that the first user has a correct understanding of the implication of the first symbol and the second user has a correct understanding of the implication of the second symbol, and ensure that the generated second symbol has the same implication as the first symbol, and that the second client may directly retrieve the second symbol locally when displaying the second symbol, without downloading the second symbol from a network, thereby reducing traffic consumption and improving response speed.

In some embodiments, after the first client sends the first symbol, the first client receives the second symbol, thereby displaying both the first symbol and the second symbol that matches the first symbol. In this way, the user of the first client may know what the second symbol that expresses the implication of the first symbol is for the user of the second client, which may help the user of the first client increase awareness of different symbol meanings, so that the user may avoid communication disorders or errors caused by different symbols used in daily communication.

In some embodiments, the sending the first symbol to a second client includes: sending the first symbol to the second client, so that the second client determines and displays the second symbol according to the first symbol. In this embodiment, the second symbol is determined by the second client. The second client may determine an implication of the first symbol after receiving the first symbol, and determine the second symbol according to the implication of the first symbol, for example, determine the second symbol having the same implication as the first symbol from the second local symbol package of the second client. In some embodiments, a mapping relationship between each symbol and an implication of the symbol in the first symbol package used by the first client, and a mapping relationship between each symbol and an implication of the symbol in the second symbol package used by the second client, may be pre-stored in the second client. The second client determines the implication of the first symbol according to the pre-stored mapping relationship after receiving the first symbol, and then determines the second symbol having the same implication as the first symbol in the second symbol package according to the implication of the first symbol. In other embodiments, the first client stores a mapping relationship between the first symbol and the second symbol, and sends the second symbol to the second client after determining the second symbol. Because the user of the first client does not need to determine the second symbol, the burden on the user of the first client will not be increased. For the user of the second client, his usage habit does not need to be changed. Therefore, user experience is improved without any additional operations.

In some embodiments of the present disclosure, the sending the first symbol to a second client includes: sending the first symbol to a server, so that the server determines the second symbol having the same implication as the first symbol and sends the second symbol to the second client. In some embodiments, the server sends the second symbol to the second client after determining the second symbol. In this case, both the first client and the second client do not need to store the mapping relationship between each symbol and an implication of the symbol, thereby reducing requirements of the first client and the second client for storage space. In the case where the first client and the second client are software, volumes of installation packages for the first client and the second client may be reduced.

In some embodiments of the present disclosure, the second symbol having the same implication as the first symbol is determined according to a mapping relationship between the first symbol and the second symbol that is established based on the implication. In some embodiments, the mapping relationship between each symbol and an implication of the symbol in the first symbol package used by the first client, and the mapping relationship between each symbol and an implication of the symbol in the second symbol package used by the second client may be pre-obtained from the server or the second client, and then a mapping relationship between symbols in the first symbol package and the second symbol package may be established. By establishing the mapping relationship between the first symbol and the second symbol based on the implication, the second symbol may be directly determined according to the first symbol, without determining the implication of the first symbol and then determining the second symbol according to the implication, thereby improving response speed and reducing occupied space. In some embodiments, the mapping relationship between the first symbol and the second symbol may be established in a form of a table, and the first symbol and the second symbol may be stored in a form of a key-value pair. For example, in a form of a database storing the first symbol, the first symbol is a main key, and the second symbol is a field of data in a row where the first symbol is located. Similarly, in a form where the second symbol is located, the second symbol is a main key, and the first symbol is a field of data in a row where the second symbol is located. In other embodiments, the corresponding relationship between the first symbol and the second symbol may alternatively be written in code. For example, an attribute representing the corresponding second symbol is added to a class of the first symbol, that is, the second symbol is set as an attribute of the first symbol in code. Similarly, the second symbol may alternatively be set as an attribute of the first symbol.

In some embodiments, the server or the second client may first determine the first symbol package used by the first client after receiving the first symbol, because different symbol packages may have the same symbol. If the implication is determined solely according to the first symbol, an error may be caused. Therefore, the second symbol having the same implication as the first symbol is determined after the first symbol package used by the first client is determined. In some embodiments, the first client may not only send the first symbol, but also send an identifier of the first symbol package corresponding to relevant regional information of the first client, thereby ensuring that the server and the second client do not misunderstand the implication of the first symbol.

In some embodiments of the present disclosure, the second symbol package is a symbol package used by the second client. In some embodiments, after the first client inputs the first symbol, symbol conversion may be performed according to the first symbol package used by the first client and the second symbol package used by the second client, so that the first symbol is converted into the second symbol having the same implication in the second symbol package. Because the second symbol package is a symbol package used by the second client, the implication of the second symbol selected from the second symbol package conforms to the expression of the user of the second client, and there will be no situation where the user of the second client cannot understand. Moreover, the second symbol package used by the second client does not need to be downloaded from the network, which may save traffic and improve response speed.

In some embodiments of the present disclosure, a target symbol package is determined according to at least one of the version, content distribution network, login user information, network address, and language of the second client, and the symbol package used by the second client. In some embodiments, the symbol package used by the second client may not be known, or although the symbol package used by the second client is known, there is no symbol in the symbol package used by the second client that has the same implication as the first symbol. In this case, the target symbol package may need to be obtained from a network. In order to ensure that symbols in the target symbol package match expressions of the user of the second client, relevant information about the second client needs to be obtained. Therefore, relevant regional information may be determined through the version of the second client, the location of the second client may be determined according to the content distribution network of the second client, the usage habits of the user may be determined according to the authorized login user information of the second client, the location of the second client may be determined according to the network address (such as IP address) of the second client, and preferred symbols used by the user of the second client may be determined according to the language of the second client. Symbols that the user of the second client is accustomed to using can be predicted through the foregoing information, and then the second symbol package that conforms to the expression of the user of the second client can be determined. By obtaining the target symbol package (for example, downloading from a network), an appropriate second symbol can also be displayed when there is no symbol corresponding to the first symbol in the second client, and a problem of failing to display in the absence of the corresponding second symbol does not occur.

In some embodiments of the present disclosure, the sending the first symbol may include: sending the first symbol itself, and/or sending implication information of the first symbol. In some embodiments, the second symbol may also be sent together, for example, the first symbol itself and the second symbol, or the implication information of the first symbol and the second symbol, or the first symbol itself, the implication information of the first symbol, and the second symbol, may be sent. In some embodiments, the first client may send at least one of the implication information of the first symbol and the second symbol when sending the first symbol itself, so that the second client or the server may accurately determine the implication of the first symbol without misunderstanding the first symbol, thereby ensuring accurate determination of the second symbol. In some embodiments, the implication information of the first symbol may be sent in a form of text or code. When sent in the form of text, text corresponding to the implication information of the first symbol may be directly sent. When sent in the form of code, code corresponding to each piece of implication information may be pre-stored in the server or the second client, so that the server or the second client may convert the code into corresponding implication information. Sending the implication information in the form of code may save traffic and reduce sending duration.

In some embodiments of the present disclosure, the symbols may include expressions, and the communication method includes: receiving a first expression selected in an expression selection panel of the first client; and sending the first expression to the second client to instruct the second client to display a second expression, or determining a second expression according to a mapping relationship between the first expression and the second expression, and sending the second expression to the second client. In some embodiments, the first expression and the second expression are different expressions having the same implication. In some embodiments, the first symbol and the second symbol may be expressions. In some embodiments, the first client may provide one or more expressions for selection. The user of the first client selects the first expression to be sent from the expression selection panel of the first client, and then the first client, the server, or the second client determines the second expression according to the mapping relationship between the first expression and the second expression, and the second client displays the second expression. In some embodiments, many expressions are extended from local film and television works, so they usually have strong regional characteristics. It is difficult for people from different regions to understand the meanings of expressions commonly used by people from other regions, and misunderstandings are prone to occur. Moreover, expressions are usually pre-stored in the client, so corresponding relationships between different expressions may be known in advance, that is, the mapping relationship between the first expression and the second expression may be predetermined and stored, which increases data processing capacity little and does not reduce the response speed of the client.

In some embodiments of the present disclosure, the symbols may include pictures, and the communication method includes: receiving a first picture selected in a picture selection panel of the first client; and sending the first picture to the second client to instruct the second client to display a second picture, or determining a second picture according to a mapping relationship between the first picture and the second picture, and sending the second picture to the second client, where the first picture and the second picture are different pictures having the same implication. In some embodiments, the first symbol and the second symbol may be pictures. In some embodiments, many pictures are extracted from film and television works or local photographic materials. These pictures have strong regional characteristics and are prone to differences in user understanding of different regions. Therefore, the first picture needs to be converted. The second picture may be determined by the first client, the server, or the second client. The second picture may be determined according to the mapping relationship between the first picture and the second picture, and the second client displays the second picture. The entire process does not require any additional processing or modification of the picture by the user of the first client when sending the picture, nor requires the user of the first client to consider the usage habits of the user of the second client, and can avoid misunderstandings or difficulties in understanding caused by usage habits.

In some embodiments of the present application, the symbols may include arrangement of symbol elements, such as arrangement of time, and the communication method includes: determining first input time information; and sending the first time information to the second client to instruct the second client to display second time information, or determining second time information according to the first time information and the regional information of the second client, and sending the second time information to the second client, where the first time information and the second time information represent the same time and have different time formats. In some embodiments, the first symbol may include the first time information, and the second symbol may include the second time information. In some embodiments, the time formats used in different regions to represent time information may be different. The time format may be an arrangement order of year, month, and day. The time format may be converted by the first client, the second client, or the server. After the first time is converted, each digit in the first time does not change, but only the arrangement order of digits may be changed, so the processing capacity is small and the response time is fast.

In order to better illustrate the method provided in the embodiment of the present disclosure, a specific embodiment is provided below. In this embodiment, symbols are expressions as an example, a first expression package is used in the first client, a second expression package is used in the second client, each expression in the first expression package has a corresponding implication, each expression in the second expression package has a corresponding implication, and the implications of each expression in the first expression package and each expression in the second expression package correspond one to one, but at least some expressions in the first expression package are different from at least some expressions in the second expression package. The first client sends the first expression in the first expression package to the server in which a mapping relationship between each expression and an implication of the expression in the first expression package and a mapping relationship between each expression and an implication of the expression in the first expression package are stored, the server determines the second corresponding expression, which is different from the first expression, in the second expression package according to the implication of the first expression and then sends the second expression to the second client, and the second client receives and displays the second expression. The first expression is replaced with the second expression to avoid user misunderstandings, and the server performs expression conversion to reduce sizes of the clients.

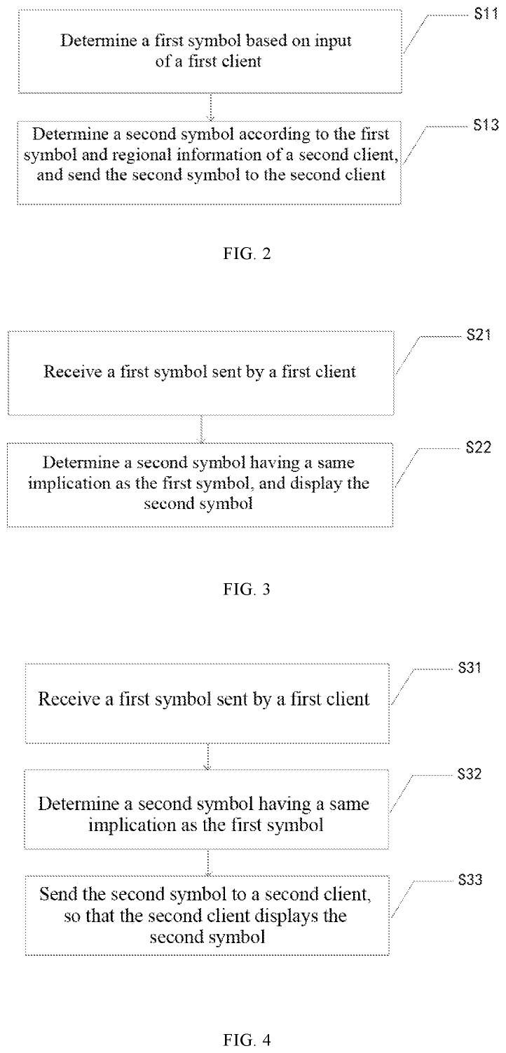

Other embodiments of the present disclosure further provide a communication method, which may be used for a second client. Refer to FIG. 3. In some embodiments, the communication method includes:

S21: Receive a first symbol sent by a first client.

S22: Determine a second symbol having a same implication as the first symbol, and display the second symbol.

In this embodiment, the first symbol and the second symbol are different symbols, and have the same implication. In some embodiments, the receiving a first symbol sent by a first client includes receiving the first symbol itself, and/or receiving implication information of the first symbol, where the implication information of the first symbol may be the implication information in any of the above embodiments, and the explanation of the implication information in the above embodiments is also applicable to this embodiment. The first client in this embodiment may be the first client in any of the foregoing embodiments, the method in this embodiment may be used for the second client, and the second client in this embodiment may be the second client in any of the foregoing embodiments. In some embodiments, the first client and the second client are in direct or indirect communication connection. After receiving the first symbol sent by the first client, the second client displays the second symbol having the same implication as the first symbol. The second symbol may be a symbol that adapts to the second client. Through the method in the embodiment of the present disclosure, misunderstandings or discomforts caused by usage habits may be avoided, the usage habits of users of the first client and the second client will not be changed, and the users do not need to perform any additional operations, so the method is more efficient and convenient.

In some embodiments of the present disclosure, the second symbol is determined from a second symbol package used by the second client. In some embodiments, the second symbol package includes at least one symbol. The second symbol package is a symbol package used by the user of the second client, and therefore conforms to the usage habits of the user of the second client. Selecting the second symbol from the second symbol package of the second client can ensure that the second symbol conforms to the usage habits of the user of the second client.

In some embodiments of the present disclosure, a target symbol package is determined according to at least one of a version, a content distribution network, authorized login user information, a network address, and a language of the second client, and a symbol package used by the second client, and the second symbol is determined from the target symbol package. In some embodiments, symbols used by the second client may not match the first symbol. In other cases, the symbols used by the second client cannot be obtained. In order to determine the second symbol corresponding to relevant regional information of the second client, the relevant regional information of the second client needs to be determined. The relevant regional information of the second client may be determined from the version, content distribution network, login user information, network address, or language of the second client. Therefore, at least one of the foregoing information is obtained to determine the target symbol package that adapts to the relevant regional information of the second client, and the second symbol is obtained from the target symbol package, to prevent a problem of failing to display in the absence of an appropriate second symbol on the second client.

Other embodiments of the present disclosure provide a control method for a server, as shown in FIG. 4, including: S31: Receive a first symbol sent by a first client.

S32: Determine a second symbol having a same implication as the first symbol.

S33: Send the second symbol to a second client, so that the second client displays the second symbol.

In some embodiments, the first symbol and the second symbol are different symbols and have the same implication. In some embodiments, the receiving a first symbol includes receiving the first symbol itself, and/or receiving implication information of the first symbol. The implication information of the first symbol may be the implication information explained in any of the above embodiments, and the explanation of the implication information of the first symbol in any of the above embodiments also applies to this embodiment. In some embodiments, the first client and the second client may be the first client and the second client in any of the above embodiments. The server is in communication connection with the first client and the second client. After receiving the first symbol sent by the first client, the server sends the second symbol having the same implication as the first symbol to the second client, where the second symbol may be a symbol that matches the usage habit of a user of the second client, thereby avoiding misunderstandings caused by usage habits.

In some embodiments of the present disclosure, the second symbol is determined from a second symbol package used by the second client. In some embodiments, the server may pre-store a corresponding relationship between each symbol and implication in the second symbol package used by the second client. After receiving the first symbol, the server determines the second symbol from the second symbol package according to the implication of the first symbol. Symbols and implications may be arbitrarily stored in the server, for example, symbols and corresponding implications are stored in a form of key-value pairs, with symbols as keys and corresponding implications as values.

In some embodiments of the present disclosure, a target symbol package is determined according to at least one of a version, a content distribution network, authorized login user information, a network address, and a language of the second client, and a symbol package used by the second client, and the second symbol is determined from the target symbol package. In some embodiments, the second client may not have a symbol that matches the implication of the first symbol, or the server may not record the second symbol package used by the second client. The server determines usage habits corresponding to relevant regional information of the second client according to at least one piece of the foregoing information, thereby obtaining the target symbol package that matches the usage habits corresponding to the relevant regional information of the second client.

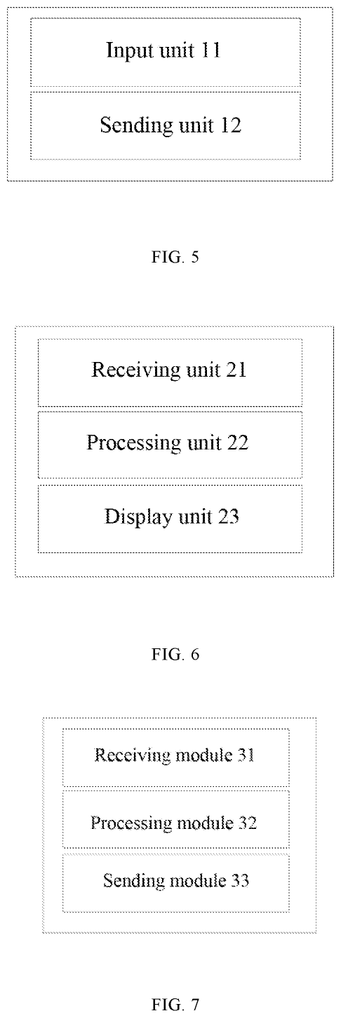

Some embodiments of the present disclosure further provide a communication client, as shown in FIG. 5, including:
an input unit 11, configured to determine a first symbol based on input of a first client; and
a sending unit 12, configured to send the first symbol to a second client to instruct the second client to display a second symbol having a same implication as the first symbol, or a sending unit 12, configured to determine a second symbol according to the first symbol and regional information of a second client, and send the second symbol to the second client;
where the first symbol and the second symbol are different symbols and have the same implication.

In some embodiments, the first symbol is related to regional information of the first client; and/or the second symbol is related to the regional information of the second client.

In some embodiments, the sending unit 12 is configured to determine the regional information of the first client according to at least one of a version, a language, a location, authorized login user information, a network address, a content distribution network, and a user choice of the first client. In some embodiments, the sending unit 12 is configured to determine the regional information of the second client according to at least one of a version, a language, a location, authorized login user information, a network address, a content distribution network, and a user choice of the second client.

In some embodiments, the first client uses a first symbol package including the first symbol. In some embodiments, the second client uses a second symbol package including the second symbol, where at least some symbols in the first symbol package and at least some symbols in the second symbol package are different but have the same implications.

In some embodiments, the sending unit 12 sends the first symbol to the second client, including: sending the first symbol to the second client, so that the second client determines and displays the second symbol according to the first symbol.

In some embodiments, the sending unit 12 sends the first symbol to the second client, including: sending the first symbol to a server, so that the server determines the second symbol having the same implication as the first symbol and sends the second symbol to the second client.

In some embodiments, the sending unit 12 is configured to determine the second symbol having the same implication as the first symbol according to a mapping relationship between the first symbol and the second symbol that is established based on the implication.

In some embodiments, the sending unit 12 is configured to determine a target symbol package according to at least one of a version, a content distribution network, login user information, a network address, and a language of the second client, and a symbol package used by the second client, and determine the second symbol from the target symbol package.

In some embodiments, the sending unit 12 is configured to determine the second symbol from the second symbol package used by the second client.

In some embodiments, the sending unit 12 sends the first symbol, including: sending the first symbol itself, and/or sending implication information of the first symbol, or sending the first symbol itself and the second symbol, or sending the implication information of the first symbol and the second symbol, or sending the first symbol itself, the implication information of the first symbol, and the second symbol.

In some embodiments, the first symbol and/or the second symbol include symbol content, or symbol content and a symbol format; and at least one of the symbol content and symbol formats of the first symbol and the second symbol is different.

In some embodiments, the symbol content includes at least one of an expression, a skin, a graphic identifier, and a picture. In some embodiments, the symbol format includes arrangement of different parts of a timestamp.

In some embodiments, the first symbol and the second symbol are symbols of the same type.

In some embodiments, the input unit 11 is configured to receive a first expression selected in an expression selection panel of the first client. The sending unit 12 is configured to send the first expression to the second client to instruct the second client to display a second expression, or determine a second expression according to a mapping relationship between the first expression and the second expression, and send the second expression to the second client, where the first expression and the second expression are different expressions having the same implication.

In some embodiments, the input unit 11 is configured to receive a first picture selected in a picture selection panel of the first client; and send the first picture to the second client to instruct the second client to display a second picture, or determine a second picture according to a mapping relationship between the first picture and the second picture, and send the second picture to the second client, where the first picture and the second picture are different pictures having the same implication.

In some embodiments, the input unit 11 is further configured to determine first input time information; and the sending unit 12 is further configured to send the first time information to the second client to instruct the second client to display second time information, or determine second time information according to the first time information and the regional information of the second client, and send the second time information to the second client, where the first time information and the second time information represent the same time and have different time formats.

Some embodiments of the present disclosure further provide a communication client, as shown in FIG. 6, including:
a receiving unit 21, configured to receive a first symbol sent by a first client;
a processing unit 22, configured to determine a second symbol having a same implication as the first symbol;
a display unit 23, configured to display the second symbol;
where the first symbol and the second symbol are different symbols and have the same implication.

In some embodiments, the processing unit 22 is configured to determine the second symbol from a second symbol package used by the second client; or the processing unit 22 is configured to determine a target symbol package according to at least one of a version, a content distribution network, authorized login user information, a network address, and a language of the second client, and a symbol package used by the second client, and determine the second symbol from the target symbol package.

Some embodiments of the present disclosure further provide a server, as shown in FIG. 7, including:
a receiving module 31, configured to receive a first symbol sent by a first client;
a processing module 32, configured to determine a second symbol having a same implication as the first symbol;
a sending module 33, configured to send the second symbol to a second client, so that the second client displays the second symbol, where the first symbol and the second symbol are different symbols and have the same implication.

In some embodiments, the processing module 32 is configured to determine the second symbol from a second symbol package used by the second client; or determine a target symbol package according to at least one of a version, a content distribution network, authorized login user information, a network address, and a language of the second client, and a symbol package used by the second client, and determine the second symbol from the target symbol package. Some embodiments of the present disclosure further provide an electronic device, including:
at least one memory and at least one processor, where
the at least one memory is configured to store program code, and the at least one processor is configured to call the program code stored in the at least one memory to perform any of the foregoing methods.

An embodiment of the present disclosure further provides a storage medium. The storage medium is used to store program code, and the program code is used to perform any of the foregoing methods.

The embodiments of the apparatuses substantially correspond to the embodiments of the methods, so relevant parts may refer to the parts of the embodiments of the methods. The embodiments of the apparatuses described above are merely illustrative, where the modules illustrated as separate modules may or may not be separate. Some or all of the modules may be selected according to actual needs to achieve the objectives of the solutions of the embodiments. Those of ordinary skill in the art may understand and implement without any creative effort.

The methods and apparatuses of the present disclosure are described above based on the embodiments and application examples. In addition, the present disclosure further provides a terminal and a storage medium, which are described below.

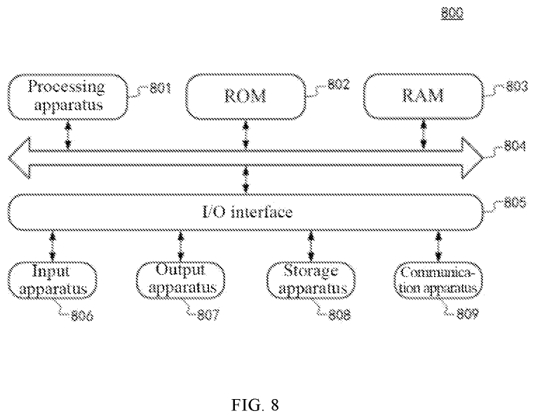

Reference is made below to FIG. 8, which illustrates a schematic diagram of the structure of an electronic device (e.g., a terminal device or a server) 800 suitable for use in implementing embodiments of the present disclosure. Terminal devices in embodiments of the present disclosure may include, but are not limited to, mobile terminals such as a cell phone, a laptop computer, a digital radio receiver, a PDA (personal digital assistant), a PAD (tablet computer), a PMP (portable multimedia player), an in-vehicle terminal (e.g., an in-vehicle navigation terminal), and the like, and fixed terminals such as a digital TV, a desktop computer, and the like. The electronic device illustrated in the figures is only an example and should not impose any limitation on the functionality and scope of use of the embodiments of the present disclosure.

The electronic device 800 may include a processing apparatus (e.g., central processor, graphics processor, etc.) 801 that may perform various appropriate actions and processes based on programs stored in a read-only memory (ROM) 802 or loaded from a storage device 808 into a random access memory (RAM) 803. Also stored in RAM 803 are various programs and data required for the operation of electronic device 800. The processing device 801, ROM 802, and RAM 803 are connected to each other via bus 804. The input/output (I/O) interface 805 is also connected to the bus 804.

Typically, the following devices can be connected to I/O interface 805: input apparatus 806 including, for example, touch screens, touch pads, keyboards, mice, cameras, microphones, accelerometers, gyroscopes, etc.; output apparatus 807 including, for example, liquid crystal displays (LCDs), speakers, vibrators, etc.; storage apparatus 808 including, for example, magnetic tapes, hard drives, etc.; and communication apparatus 809. communication apparatus 809 may allow the electronic device 800 to communicate wirelessly or wired with other devices to exchange data. Although the drawings illustrate the electronic device 800 with various devices, it should be understood that it is not required to implement or have all of the devices illustrated. More or fewer devices may alternatively be implemented or available.

In particular, according to embodiments of the present disclosure, the process described above with reference to the flowchart may be implemented as a computer software program. For example, embodiments of the present disclosure include a computer program product comprising a computer program carried on a computer readable medium, the computer program comprising program code for performing the method shown in the flowchart. In such an embodiment, the computer program may be downloaded and installed from a network via a communication apparatus 809, or from a storage apparatus 808, or from a ROM 802. When this computer program is executed by the processing apparatus 801, the above-described functions as defined in the method of this disclosed embodiment are performed.

It is to be noted that the computer-readable medium described above in this disclosure may be a computer-readable signal medium or a computer-readable storage medium or any combination of the above. The computer readable storage medium may be, for example—but not limited to—an electrical, magnetic, optical, electromagnetic, infrared, or semiconductor system, device, or device, or any combination of the above. More specific examples of computer-readable storage media may include, but are not limited to: electrically connected with one or more wires, portable computer disks, hard disks, random access memory (RAM), read-only memory (ROM), erasable programmable read-only memory (EPROM or flash memory), optical fiber, portable compact disk read-only memory (CD-ROM), optical storage devices, or any of the above, magnetic memory devices, or any suitable combination of the foregoing. In the present disclosure, a computer-readable storage medium may be any tangible medium that contains or stores a program that may be used by or in combination with an instruction execution system, device, or device. And in the present disclosure, a computer-readable signal medium may include a data signal propagated in the baseband or as part of a carrier wave that carries computer-readable program code. Such propagated data signals may take a variety of forms, including but not limited to electromagnetic signals, optical signals, or any suitable combination of the foregoing. Computer-readable signal medium can also be any computer-readable medium other than computer-readable storage media, the computer-readable signal medium can send, propagate or transmit the program for use by or in combination with the instruction execution system, device or device. The program code contained on the computer-readable medium may be transmitted using any suitable medium, including but not limited to: wire, fiber optic cable, RF (radio frequency), etc., or any suitable combination of the above.

In some implementations, the client, server may communicate using any currently known or future developed network protocol such as HTTP (HyperText Transfer Protocol), and may interconnect with any form or medium of digital data communication (e.g., a communication network). Examples of communication networks include local area networks (“LANs”), wide area networks (“WANs”), inter-networks (e.g., the Internet), and end-to-end networks (e.g., ad hoc end-to-end networks), as well as any currently known or future developed networks.

The above computer readable medium may be contained in the above electronic device; or it may be present separately and not assembled into the electronic device.

The above computer readable medium carries one or more programs which, when executed by the electronic device, cause the electronic device to perform the method of the present disclosure as described above.

Computer program code for performing the operations of the present disclosure may be written in one or more programming languages or combinations thereof, said programming languages including object-oriented programming languages-such as Java, Smalltalk, C++, and also including conventional procedural programming languages-such as “C” language or similar programming languages. The program code may be executed entirely on the user's computer, partially on the user's computer, as a stand-alone package, partially on the user's computer and partially on a remote computer, or entirely on a remote computer or server. In the case of a remote computer, the remote computer may be connected to the user computer over any kind of network-including a local area network (LAN) or a wide area network (WAN)—or, alternatively, may be connected to an external computer (e.g., using an Internet service provider to connect over the Internet).

The flowcharts and block diagrams in the accompanying drawings illustrate the possible implementations of the architecture, functionality, and operation of systems, methods, and computer program products in accordance with various embodiments of the present disclosure. At this point, each box in a flowchart or block diagram may represent a module, program segment, or portion of code that contains one or more executable instructions for implementing a specified logical function. It should also be noted that in some implementations as replacements, the functions indicated in the boxes may also occur in a different order than that indicated in the accompanying drawings. For example, two boxes represented one after the other can actually be executed in substantially parallel, and they can sometimes be executed in the opposite order, depending on the function involved. Note also that each box in the block diagram and/or flowchart, and the combination of boxes in the block diagram and/or flowchart, may be implemented with a dedicated hardware-based system that performs the specified function or operation, or may be implemented with a combination of dedicated hardware and computer instructions.

The units described in the embodiments of the present disclosure may be implemented by means of software, or by means of hardware. Wherein, the name of the unit does not in a certain case constitute a limitation of the unit itself.

The functions described above herein may be performed, at least in part, by one or more hardware logic components. For example, non-limitingly, exemplary types of hardware logic components that may be used include: field-programmable gate arrays (FPGAs), application-specific integrated circuits (ASICs), application-specific standard products (ASSPs), systems-on-chip (SOCs), complex programmable logic devices (CPLDs), and the like.

In the context of the present disclosure, a machine-readable medium may be a tangible medium that may contain or store a program for use by or in conjunction with an instruction execution system, device, or apparatus. The machine-readable medium may be a machine-readable signal medium or a machine-readable storage medium. Machine readable media may include, but are not limited to, electronic, magnetic, optical, electromagnetic, infrared, or semiconductor systems, devices, or equipment, or any suitable combination of the foregoing. More specific examples of machine-readable storage media would include one or more wire-based electrical connections, portable computer disks, hard disks, random access memory (RAM), read-only memory (ROM), erasable programmable read-only memory (EPROM or flash memory), optical fiber, convenient compact disk read-only memory (CD-ROM), optical storage devices, magnetic storage devices, or any suitable combination of the above any suitable combination of the above.

According to one or more embodiments of the present disclosure, provide a communication method, comprising:
determining a first symbol based on input of a first client; and
sending the first symbol to a second client to instruct the second client to display a second symbol having a same implication as the first symbol; or
determining a second symbol according to the first symbol and regional information of a second client, and sending the second symbol to the second client;
wherein the first symbol and the second symbol are different symbols and have the same implication.

According to one or more embodiments of the present disclosure, provide a communication method, the first symbol is related to regional information of the first client; and/or
the second symbol is related to the regional information of the second client.

According to one or more embodiments of the present disclosure, provide a communication method, the regional information of the first client is determined according to at least one of a version, a language, a location, authorized login user information, a network address, a content distribution network, and a user choice of the first client; and/or
the regional information of the second client is determined according to at least one of a version, a language, a location, authorized login user information, a network address, a content distribution network, and a user choice of the second client.

According to one or more embodiments of the present disclosure, provide a communication method, the first client uses a first symbol package comprising the first symbol; and
the second client uses a second symbol package comprising the second symbol, wherein
at least some symbols in the first symbol package and at least some symbols in the second symbol package are different but have the same implications.

According to one or more embodiments of the present disclosure, provide a communication method, wherein the sending the first symbol to a second client comprises:
sending the first symbol to the second client, so that the second client determines and displays the second symbol according to the first symbol.

According to one or more embodiments of the present disclosure, provide a communication method, wherein the sending the first symbol to a second client comprises:
sending the first symbol to a server, so that the server determines the second symbol having the same implication as the first symbol and sends the second symbol to the second client.

According to one or more embodiments of the present disclosure, provide a communication method, determining the second symbol having the same implication as the first symbol according to a mapping relationship between the first symbol and the second symbol that is established based on the implication.

According to one or more embodiments of the present disclosure, provide a communication method, a target symbol package is determined according to at least one of a version, a content distribution network, login user information, a network address, and a language of the second client, and a symbol package used by the second client, and the second symbol is determined from the target symbol package; or
the second symbol is determined from the second symbol package used by the second client.

According to one or more embodiments of the present disclosure, provide a communication method, wherein the sending the first symbol comprises:
sending the first symbol itself, and/or sending implication information of the first symbol, or sending the first symbol itself and the second symbol, or sending the implication information of the first symbol and the second symbol, or sending the first symbol itself, the implication information of the first symbol, and the second symbol.
the first symbol and/or the second symbol comprise symbol content, or symbol content and a symbol format; and
at least one of the symbol content and symbol formats of the first symbol and the second symbol is different.

According to one or more embodiments of the present disclosure, provide a communication method, the symbol content comprises at least one of an expression, a skin, a graphic identifier, and a picture; and/or the symbol format comprises arrangement of different parts of a timestamp.

According to one or more embodiments of the present disclosure, provide a communication method, the first symbol and the second symbol are symbols of the same type.

According to one or more embodiments of the present disclosure, provide a communication method, comprising:
receiving a first expression selected in an expression selection panel of the first client; and
sending the first expression to the second client to instruct the second client to display a second expression, or determining a second expression according to a mapping relationship between the first expression and the second expression, and sending the second expression to the second client, wherein
the first expression and the second expression are different expressions having the same implication.

According to one or more embodiments of the present disclosure, provide a communication method, comprising:
receiving a first picture selected in a picture selection panel of the first client; and
sending the first picture to the second client to instruct the second client to display a second picture, or determining a second picture according to a mapping relationship between the first picture and the second picture, and sending the second picture to the second client, wherein
the first picture and the second picture are different pictures having the same implication.

According to one or more embodiments of the present disclosure, provide a communication method, comprising:
determining first input time information; and
sending the first time information to the second client to instruct the second client to display second time information, or determining second time information according to the first time information and the regional information of the second client, and sending the second time information to the second client, wherein
the first time information and the second time information represent the same time and have different time formats.

According to one or more embodiments of the present disclosure, provide a communication method, comprising:
receiving a first symbol sent by a first client; and
determining a second symbol having a same implication as the first symbol, and displaying the second symbol, wherein
the first symbol and the second symbol are different symbols and have the same implication.

According to one or more embodiments of the present disclosure, provide a communication method, determining the second symbol from a second symbol package used by the second client; or
determining a target symbol package according to at least one of a version, a content distribution network, authorized login user information, a network address, and a language of the second client, and determining the second symbol from the target symbol package.

According to one or more embodiments of the present disclosure, provide a control method for a server, comprising:
receiving a first symbol sent by a first client;
determining a second symbol having a same implication as the first symbol;
sending the second symbol to a second client, so that the second client displays the second symbol, wherein
the first symbol and the second symbol are different symbols and have the same implication.

According to one or more embodiments of the present disclosure, provide a control method for a server, wherein the second symbol is determined from a second symbol package used by the second client; or
a target symbol package is determined according to at least one of a version, a content distribution network, login user information, a network address, and a language of the second client, and a symbol package used by the second client, and the second symbol is determined from the target symbol package.

According to one or more embodiments of the present disclosure, provide a communication client, comprising:
an input unit, configured to determine a first symbol based on input of a first client; and
a sending unit, configured to send the first symbol to a second client to instruct the second client to display a second symbol having a same implication as the first symbol, or a sending unit, configured to determine a second symbol according to the first symbol and regional information of a second client, and send the second symbol to the second client;
wherein the first symbol and the second symbol are different symbols and have the same implication.

According to one or more embodiments of the present disclosure, provide a communication client, comprising:
a receiving unit, configured to receive a first symbol sent by a first client;
a processing unit, configured to determine a second symbol having a same implication as the first symbol; and
a display unit, configured to display the second symbol, wherein
the first symbol and the second symbol are different symbols and have the same implication.

According to one or more embodiments of the present disclosure, provide a server, comprising:
a receiving module, configured to receive a first symbol sent by a first client;
a processing module, configured to determine a second symbol having a same implication as the first symbol; and
a sending module, configured to send the second symbol to a second client, so that the second client displays the second symbol, wherein
the first symbol and the second symbol are different symbols and have the same implication.

According to one or more embodiments of the present disclosure, provide an electronic device, comprising:
at least one memory and at least one processor, wherein
the at least one memory is configured to store program code, and the at least one processor is configured to call the program code stored in the at least one memory to perform the method according to any one of above.

According to one or more embodiments of the present disclosure, provide a storage medium storing program code for performing the method according to any one of above.

The above description is only a better embodiment of the present disclosure and a description of the technical principles applied. It should be understood by those skilled in the art that the scope of the disclosure covered by the present disclosure is not limited to technical solutions resulting from a particular combination of the technical features described above, but should also cover other technical solutions resulting from any combination of the technical features described above or their equivalent features without departing from the above disclosed idea. For example, the above features are interchangeable with (but not limited to) the technical features with similar functions disclosed in this disclosure.

Furthermore, although a specific order is used to depict the individual operations, this should not be interpreted as requiring that these operations be executed in the specific order shown or in sequential order of execution. Multitasking and parallel processing may be advantageous in certain environments. Again, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments individually or in any suitable sub-combination.

Although the present subject matter has been described using language specific to structural features and/or method logical actions, it should be understood that the subject matter defined in the appended claims is not necessarily limited to the particular features or actions described above. Rather, the particular features and actions described above are merely exemplary forms of claim fulfillment.

1. A communication method, comprising:
determining a first symbol based on input of a first client; and
sending the first symbol to a second client to instruct the second client to display a second symbol having a same implication as the first symbol; or
determining a second symbol according to the first symbol and regional information of a second client, and sending the second symbol to the second client, wherein the first symbol and the second symbol are different symbols and have the same implication.

2. The communication method according to claim 1, wherein
the first symbol is related to regional information of the first client; and/or
the second symbol is related to the regional information of the second client.

3. The communication method according to claim 2, wherein
the regional information of the first client is determined according to at least one of a version, a language, a location, authorized login user information, a network address, a content distribution network, and a user choice of the first client; and/or
the regional information of the second client is determined according to at least one of a version, a language, a location, authorized login user information, a network address, a content distribution network, and a user choice of the second client.

4. The communication method according to claim 1, wherein
the first client uses a first symbol package comprising the first symbol; and
the second client uses a second symbol package comprising the second symbol, wherein
at least some symbols in the first symbol package and at least some symbols in the second symbol package are different but have the same implications.

5. The communication method according to claim 1, wherein the sending the first symbol to a second client comprises:
sending the first symbol to the second client, so that the second client determines and displays the second symbol according to the first symbol.

6. The communication method according to claim 1, wherein the sending the first symbol to a second client comprises:
sending the first symbol to a server, so that the server determines the second symbol having the same implication as the first symbol and sends the second symbol to the second client.

7. The communication method according to claim 1, further comprising: determining the second symbol having the same implication as the first symbol according to a mapping relationship between the first symbol and the second symbol that is established based on the implication.

8. The communication method according to claim 1, wherein
a target symbol package is determined according to at least one of a version, a content distribution network, login user information, a network address, and a language of the second client, and a symbol package used by the second client, and the second symbol is determined from the target symbol package; or
the second symbol is determined from the second symbol package used by the second client.

9. The communication method according to claim 1, wherein the sending the first symbol comprises:
sending the first symbol itself, and/or sending implication information of the first symbol, or sending the first symbol itself and the second symbol, or sending the implication information of the first symbol and the second symbol, or sending the first symbol itself, the implication information of the first symbol, and the second symbol.

10. The communication method according to claim 1, wherein
the first symbol and/or the second symbol comprise symbol content, or symbol content and a symbol format; and
at least one of the symbol content and symbol formats of the first symbol and the second symbol is different.

11. The communication method according to claim 10, wherein
the symbol content comprises at least one of an expression, a skin, a graphic identifier, and a picture; and/or
the symbol format comprises arrangement of different parts of a timestamp.

12. The communication method according to claim 1, wherein
the first symbol and the second symbol are symbols of the same type.

13. The communication method according to claim 1, comprising:
receiving a first expression selected in an expression selection panel of the first client; and
sending the first expression to the second client to instruct the second client to display a second expression, or determining a second expression according to a mapping relationship between the first expression and the second expression, and sending the second expression to the second client, wherein
the first expression and the second expression are different expressions having the same implication.

14. The communication method according to claim 1, comprising:
receiving a first picture selected in a picture selection panel of the first client; and
sending the first picture to the second client to instruct the second client to display a second picture, or determining a second picture according to a mapping relationship between the first picture and the second picture, and sending the second picture to the second client, wherein
the first picture and the second picture are different pictures having the same implication.

15. The communication method according to claim 1, comprising:
determining first input time information; and
sending the first time information to the second client to instruct the second client to display second time information, or determining second time information according to the first time information and the regional information of the second client, and sending the second time information to the second client, wherein
the first time information and the second time information represent the same time and have different time formats.

16. A communication method, comprising:
receiving a first symbol sent by a first client; and
determining a second symbol having a same implication as the first symbol, and displaying the second symbol, wherein
the first symbol and the second symbol are different symbols and have the same implication.

17. The communication method according to claim 16, wherein
determining the second symbol from a second symbol package used by the second client; or
determining a target symbol package according to at least one of a version, a content distribution network, authorized login user information, a network address, and a language of the second client, and determining the second symbol from the target symbol package.

18. A control method for a server, comprising:
receiving a first symbol sent by a first client;
determining a second symbol having a same implication as the first symbol; and
sending the second symbol to a second client, so that the second client displays the second symbol, wherein
the first symbol and the second symbol are different symbols and have the same implication.

19. The control method for a server according to claim 18, wherein
the second symbol is determined from a second symbol package used by the second client; or
a target symbol package is determined according to at least one of a version, a content distribution network, login user information, a network address, and a language of the second client, and a symbol package used by the second client, and the second symbol is determined from the target symbol package.

20. (canceled)

21. (canceled)

22. (canceled)

23. (canceled)

24. (canceled)

25. The communication method according to claim 1, wherein after sending the first symbol to a second client to instruct the second client to display a second symbol having a same implication as the first symbol, or, after determining a second symbol according to the first symbol and regional information of a second client and sending the second symbol to the second client, the communication method further comprises:
the first client displaying both the first symbol and the second symbol.
